(19) United States
(12) Patent Application Publication
(10) Pub. No.: US 2024/0308580 A1
(43) Pub. Date: Sep. 19, 2024

(54) METHOD TO CONTROL A STEER-BY-WIRE STEERING SYSTEM OF A ROAD VEHICLE WITH A FEEDBACK ACTUATOR HAVING AN INGRESS MODE AND AN EGRESS MODE

(71) Applicants: thyssenkrupp Presta AG, Eschen (LI); Honda Motor Co., Ltd., Tokyo (JP)

(72) Inventors: Miklós ARÁNYI, Altstätten (CH); Péter KAKAS, Budapest (HU); Munetsugu HANJI, Wako-shi (JP); Ryo KATO, Wako-shi (JP); Yosuke OJIMA, Wako-shi (JP); Yoshinobu WATANABE, Wako-shi (JP)

(21) Appl. No.: 18/675,496

(22) Filed: May 28, 2024

Related U.S. Application Data
(63) Continuation of application No. PCT/EP2021/083479, filed on Nov. 30, 2021.

(51) Int. Cl. B62D 6/00

(52) U.S. Cl. CPC B62D 6/008

(57) ABSTRACT

A method to control a steer-by-wire steering system for a road vehicle, the steer-by-wire steering system including a steering wheel, a road wheel actuator to actuate road wheels, and a feedback actuator to apply a feedback torque to the steering wheel, the method including, if an ingress situation is detected, switching on the feedback actuator and providing a resistance torque against rotation of the steering wheel in an ingress mode, and if a normal steering system shut down procedure is finished, activating an egress mode of the feedback actuator and providing a resistance torque against rotation of the steering wheel.

### CROSS REFERENCE TO RELATED APPLICATIONS

This application claims the benefit of priority to PCT Application No. PCT/EP2021/083479 filed on Nov. 30, 2021, the entire contents of which are hereby incorporated herein by reference.

### BACKGROUND OF THE INVENTION

### 1. Field of the Invention

The present invention relates to methods to control steer-by-wire steering systems of road vehicles and steer-by-wire steering systems for road vehicles.

### 2. Description of the Related Art

In a steer-by-wire steering system, the vehicle's steering wheel is disengaged from the steering mechanism. In such a steering system, there is no mechanical coupling between the steering wheel and the steering gear. Steering movement is achieved by a steering actuator with an electric motor. The steering actuator operates in response to detected values of various steering parameters, such as a steering wheel angle and a vehicle speed, etc. The detected values are communicated electronically to the steering actuator from sensors, whereby the electric motor drives the rack and orients the steerable wheels in the desired direction.

Even though the mechanical linkage between the steering wheel and the road wheels has been eliminated, a steer-by-wire steering system is expected to produce the same functions and steering feel as a conventional mechanically linked steering system. The forces generated in moving the road wheels have to be fed back to the steering wheel to provide information for directional control to the driver. The feedback also contributes to a feeling of steering referred to as steering feel. In steer-by-wire steering systems, the feedback and steering feel respectively is generated with a feedback actuator connected to the steering wheel.

When the vehicle is turned off, the steering shaft and the steering are per se free to rotate as they are not connected to any mechanical resistance. However, many operators of vehicles use the steering as a handle during ingress and egress. Conventional steering columns are hard-steering although the vehicle is turned off, as they are mechanically connected to the wheels.

### SUMMARY OF THE INVENTION

Example embodiments of the present invention provide methods by which steering wheels of steer-by-wire steering systems of road vehicles can be used as handles during ingress and egress.

A method to control a steer-by-wire steering system for a road vehicle is provided, the steer-by-wire steering system including a steering wheel, a road wheel actuator to actuate road wheels, and a feedback actuator to apply a feedback torque to the steering wheel, the method including, if an ingress situation is detected, switching on the feedback actuator and providing a resistance torque against rotation of the steering wheel in an ingress mode, and if a normal steering system shut down procedure is finished, activating an egress mode of the feedback actuator and providing the resistance torque against rotation of the steering wheel.

Even though a mechanical resistance is missing in steer-by-wire systems, with this method, the steering wheel can be used as a handle when getting in or out of the vehicle.

Preferably, the resistance torque is provided by a position control mode of the feedback actuator, which maintains an initial position of the steering wheel and makes it difficult to move the steering wheel, when the ingress or egress mode is activated.

It is advantageous if the ingress and/or egress mode is terminated due to at least one signal and/or after a certain time period has elapsed. The time period is preferably an adjustable parameter. The at least one signal can be a detection of a decrease in grid voltage below a certain value and/or a vehicle request signal.

Preferably, the feedback actuator is shut down when the egress mode is terminated.

It is preferred that the normal operation mode of the feedback actuator is started or the feedback torque actuation for providing the resistance torque is switched off when the ingress mode is ended.

Preferably, the ingress situation is detected based on signals from the vehicle communication, the steering angle signal, and/or the steering torque signal, and/or other signals which represent a hands-on situation on the steering wheel.

Further, according to an example embodiment of the present invention, a steer-by-wire steering system for a road vehicle is configured to perform the method described above.

The above and other elements, features, steps, characteristics and advantages of the present invention will become more apparent from the following detailed description of the example embodiments with reference to the attached drawings.

### BRIEF DESCRIPTION OF THE DRAWINGS

Example embodiments of the present invention will be described with reference to the drawings.

FIG. 1 is a schematic illustration of a steer-by-wire steering system of a motor vehicle.

FIG. 2 is a block diagram of an ingress mode and an egress mode.

### DETAILED DESCRIPTION OF THE EXAMPLE EMBODIMENTS

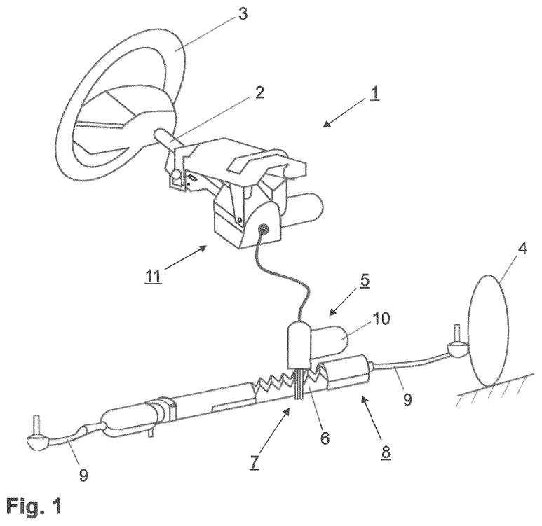

FIG. 1 is a schematic drawing of a steer-by-wire system 1 with a steering shaft 2 connected to steering wheel 3. There is no mechanical connection between the steering wheel 3 and road wheels 4. A road wheel actuator 5 operates a gear rack 6 via a rack-and-pinion gear 7, which is part of a front wheel axle 8. The front wheel axle 8 includes two tie rods 9 for road wheels 4, of which only one road wheel 4 is shown.

When a driver operates the steering wheel 3, the steering shaft 2 is rotated, which is detected by a shaft sensor, which is not shown in the drawings. When the vehicle is switched on, a controller 10 calculates an operation signal for the road wheel actuator 5 from the signal detected by the shaft sensor. By operating gear rack 6 with the operation signal, the front wheel axle 8 is moved sideways and the road wheels 4 are turned. At the same time, forces introduced in the wheel axle 8 from the road wheels 4 are recognized by another sensor not shown in the drawings, and a feedback signal is calculated, which is applied to the steering shaft 2 by a feedback actuator 11, so that the operator can recognize the feedback in the steering wheel 3.

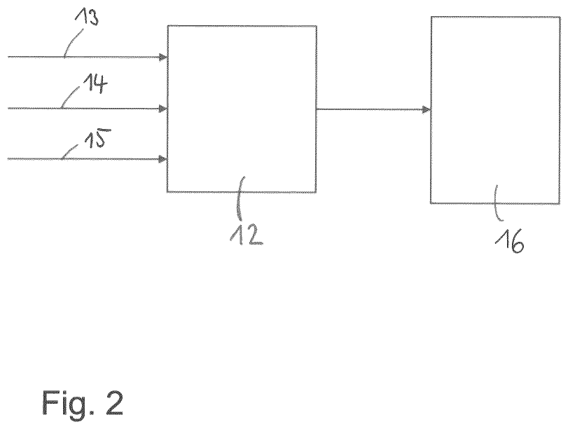

FIG. 2 shows schematically a block diagram of a method to control the steering system with an ingress/egress mode. In a first step 12, the system detects an ingress or egress situation.

An ingress situation can be detected based on signals from the vehicle communication 13, e.g., doors state, doors lock state, enable signal from the vehicle, a wake-up signal based on the steering angle signal 14, e.g., if there is a change in a steering angle of the steering wheel higher than a defined threshold value, and/or based on other signals which represent a hands-on situation on the steering wheel 15, e.g., generated by a capacitive sensor implemented in the steering wheel. If an ingress situation is detected, the feedback actuator is switched on in an ingress mode and simulates a mechanical resistance, making it difficult to move the steering wheel, such that it can be used as a handle to get into the car. This can be achieved by a position control mode of the feedback actuator 16, which maintains the initial position of the steering wheel when the feedback actuator is activated. To imitate high mechanical resistance, the feedback actuator applies a resistance against rotation to the steering shaft.

The ingress mode can be terminated due to signals, e.g., when the power supply voltage drops below a certain value and/or due to a vehicle request and/or after a certain time period has elapsed, the time period being an adjustable parameter. When the ingress mode is terminated, the normal operation mode of the feedback actuator is started or the feedback torque actuation to provide a resistance torque is ended.

The feedback actuator activates an egress mode 12 after the normal steering system shut down procedure is finished. In the egress mode, the feedback actuator simulates a high mechanical resistance, making it difficult to move the steering wheel, such that it can be used as a handle to get out of the car. This can be achieved by a position control mode of the feedback actuator 16, which maintains the initial position of the steering wheel when the feedback actuator is activated. The egress mode can be terminated due to signals, e.g., when the power supply voltage decreases below a certain value and/or due to a vehicle request and/or after a certain time period has elapsed, the time period being an adjustable parameter. When the egress mode is terminated, the feedback actuator is shut down.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method to control a steer-by-wire steering system for a road vehicle, the steer-by-wire steering system including a steering wheel, a road wheel actuator to actuate road wheels, and a feedback actuator to apply a feedback torque to the steering wheel, the method comprising:
if an ingress situation is detected, switching on the feedback actuator and providing a resistance torque against rotation of the steering wheel in an ingress mode; and
if a normal steering system shut down procedure is finished, activating an egress mode of the feedback actuator and providing the resistance torque against rotation of the steering wheel.

2. The method according to claim 1, wherein the resistance torque is provided in a position control mode of the feedback actuator, which maintains an initial position of the steering wheel and makes it harder to move the steering wheel, when the ingress mode or the egress mode is activated.

3. The method according to claim 1, wherein the ingress mode and/or the egress mode is terminated due to at least one signal and/or after a certain time period has elapsed.

4. The method according to claim 3, wherein the at least one signal is a detection of a decrease in grid voltage below a certain value and/or a vehicle request signal.

5. The method according to claim 1, wherein the feedback actuator is shut down when the egress mode is terminated.

6. The method according to claim 1, wherein the normal operation mode of the feedback actuator is started or the feedback torque actuation is ended when the ingress mode is terminated.

7. The method according to claim 1, wherein the ingress situation is detected based on:
signals from a vehicle communication module;
a steering angle signal; and/or
a steering torque signal; and/or
other signals which represent a hands-on situation on the steering wheel.

8. A steer-by-wire steering system for a road vehicle configured to perform the method according to claim 1.
